(19) United States
(12) Patent Application Publication
(10) Pub. No.: US 2014/0350975 A1
(43) Pub. Date: Nov. 27, 2014

(54) Method for facilitating automatic scheduling of a rideshare trip

(71) Applicant: Alexander Paperno, St. Petersburg (RU)

(72) Inventor: Alexander Paperno, St. Petersburg (RU)

(21) Appl. No.: 14/285,356

(22) Filed: May 22, 2014

Related U.S. Application Data
(60) Provisional application No. 61/826,563, filed on May 23, 2013.

(51) Int. Cl. G06Q 10/02; G06Q 10/10

(52) U.S. Cl. CPC G06Q 10/02; G06Q 10/1095
USPC 705/5

(57) ABSTRACT

Methods are provided for facilitating automatic scheduling of a meeting between a driver and a passenger for a rideshare trip. Readiness information of the passenger, readiness information of the driver and original vehicle location are acquired. A meeting location corresponding to the rideshare trip is determined. A pre-meeting driving time corresponding to the original vehicle location and the meeting location is determined using a GIS. A readiness time interval of the passenger corresponding to the readiness information of the passenger and a readiness time interval of the driver corresponding to the readiness information of the driver are determined. Scheduling information corresponding to the rideshare trip is determined based at least in part on a function of at least the readiness time interval of the passenger, the readiness time interval of the driver and the pre-meeting driving time. The methods are performed on one or more computing devices.

### CROSS-REFERENCE TO RELATED APPLICATIONS

This application claims the benefit of U.S. Provisional Patent Application No. 61/826,563, filed on May 23, 2013, entitled Method for facilitating automatic scheduling of a rideshare trip, which is herein incorporated by reference in its entirety.

### BACKGROUND OF THE INVENTION

The state-of-the-art rideshare systems employ several different methods of scheduling of rideshare trips, i.e. determining start time of the trips. These existing methods have various drawbacks and/or limitations.

Conventional carpooling and rideshare systems require users to specify either exact start time or start time frame several days or hours in advance. Users of such systems are expected not to change their plans regarding their trips. Often it is just not possible to specify the start time of a trip. For example, users working flex hours can't use such systems for commuting. Other persons might be unwilling to make plans in advance. Also ahead-of-time scheduling doesn't fit ad-hoc trips. Even in cases where users find it appropriate to schedule a rideshare trip in advance, such trips frequently get cancelled due to change of plans, delays or other issues that may arise in the time interval between making the rideshare agreement and the start of the trip. Such cancellations lead to user frustration and unwillingness to continue using of a rideshare system. Often the participants of a carpool have to re-negotiate the exact time of a trip every time, usually in some informal way outside of the carpool system.

In dynamic rideshare systems users publish rideshare requests when they are ready for a ride.

Some of these systems schedule trips for “right away” time, i.e. the ride may begin as soon as an agreement between passenger and driver is made. Such scheduling is often inconvenient for users because they can't predict when the trip starts before an agreement is made and therefore can't manage their time effectively. For example, if a user asks for a ride “right away”, he/she is not supposed to work on a task that might take more than a couple of minutes to finalize, because he/she may need to start the rideshare trip at any moment.

Other dynamic rideshare systems allow users to specify exact start time or start time frame, usually in several minutes ahead of a planned ride. In practice, such systems require a “critical mass” of both drivers and passengers so that there is a significant amount of requests for a ride and ride offers that have almost exact start time. The “critical mass” issue in such systems allows them to be used only in places with very high number of users. Allowing users to filter or choose those that they are willing to drive with makes this issue even harder to overcome in such systems.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Embodiments of the present invention include methods for facilitating automatic scheduling of a meeting between a driver and a passenger for a rideshare trip. Readiness information of the passenger, readiness information of the driver and an original vehicle location are acquired. A meeting location corresponding to the rideshare trip is determined. A pre-meeting driving time corresponding to the original vehicle location and the meeting location is determined using a GIS. A readiness time interval of the passenger corresponding to the readiness information of the passenger and a readiness time interval of the driver corresponding to the readiness information of the driver are determined. Scheduling information corresponding to the rideshare trip is determined based at least in part on a function of at least the readiness time interval of the passenger, the readiness time interval of the driver and the pre-meeting driving time. The methods are performed on one or more computing devices.

In further embodiments, the original vehicle location is a geographic location of a vehicle of the driver determined by means of a locating device, such as a GPS receiver.

In other embodiments, the original vehicle location is a geographic location specified by the driver by means of a user interface.

In further embodiments, determination of the scheduling information is based at least in part on a maximum value of the readiness time interval of the passenger and the sum of the readiness time interval of the driver and the pre-meeting driving time.

In further embodiments, the readiness information of the passenger is received from a rideshare participant device of the passenger.

In further embodiments, the readiness information of the driver is received from a rideshare participant device of the driver.

In further embodiments, the original vehicle location is received from the rideshare participant device of the driver.

In further embodiments, the methods for facilitating automatic scheduling of a meeting between a driver and a passenger for a rideshare trip further comprise the step of delivering the scheduling information to the rideshare participant device of the passenger and the rideshare participant device of the driver. The methods are performed on a rideshare server.

In other embodiments, the methods for facilitating automatic scheduling of a meeting between a driver and a passenger for a rideshare trip further comprise the step of delivering the scheduling information to the rideshare participant device of the passenger. The methods are performed on the rideshare participant device of the driver, the device operating in a peer-to-peer environment.

In other embodiments, the methods for facilitating automatic scheduling of a meeting between a driver and a passenger for a rideshare trip further comprise the steps of delivering the readiness time interval of the passenger and the pre-meeting driving time to the rideshare participant device of the driver and delivering the readiness time interval of the driver and the pre-meeting driving time to the rideshare participant device of the passenger. Scheduling information corresponding to the rideshare trip is determined on at least one of the rideshare participant device of the passenger and the rideshare participant device of the driver. Other steps of the methods are performed on a rideshare server.

Other methods according to embodiments will be or become apparent to one with skill in the art upon review of the following drawings and detailed description. It is intended that all such additional methods be included within this description, be within the scope of the present invention, and be protected by the accompanying claims.

### BRIEF DESCRIPTION OF THE DRAWINGS

Embodiments of the present invention may become apparent from the following detailed description of arrangements, example embodiments, and the claims when read in connection with the accompanying drawings. While the foregoing and following written and illustrated disclosure focuses on disclosing arrangements and example embodiments of the invention, it should be clearly understood that the same is by way of illustration and example only and embodiments of the invention are not limited thereto.

FIG. 1 is a block diagram illustrating an exemplary rideshare participant device suitable for use in a client-server environment in accordance with some embodiments of the present invention.

FIG. 2 is a block diagram illustrating an exemplary rideshare server suitable for use in accordance with some embodiments of the present invention.

FIG. 3 is a block diagram illustrating an exemplary rideshare participant device suitable for use in a peer-to-peer environment in accordance with some embodiments of the present invention.

FIG. 4A is a timeline diagram illustrating the scheduling for a rideshare trip in accordance with some embodiments of the present invention.

FIG. 4B is a timeline diagram further illustrating the scheduling for a rideshare trip in accordance with some embodiments of the present invention.

FIG. 5 is a context diagram illustrating interaction between rideshare server, rideshare participant device of a passenger and rideshare participant device of a driver in accordance with some embodiments of the present invention.

FIG. 6 is an activity diagram illustrating steps performed by rideshare server, rideshare participant device of a passenger and rideshare participant device of a driver in accordance with some embodiments of the present invention.

### DETAILED DESCRIPTION OF PREFERRED EMBODIMENTS

Before the present invention is described, it is to be understood that this invention is not limited to the particular embodiments described, as such may, of course, vary. It is also to be understood that the phraseology and the terminology used herein is for the purpose of description, and should not be regarded as limiting.

The following detailed description refers to the accompanying drawings. Throughout the description, similar reference numbers may be used to identify similar elements in the several embodiments and drawings.

For purposes of explanation, numerous specific details are set forth in order to provide a thorough understanding of the invention. It will be apparent, however, to one skilled in the art that embodiments of the invention can be practiced without these specific details.

Reference throughout this description to “some embodiments,” “certain embodiments,” or “an embodiment” means that a particular feature, structure or characteristic described in connection with the embodiment is included in at least some embodiments. Thus, appearances of the phrases “in some embodiments” or “in an embodiment” in various places throughout this specification are not necessarily all referring to the same embodiment and may refer to one or more of the same or different embodiments. Furthermore, the particular features, structures or characteristics may be combined in any suitable manner, as would be apparent to one of ordinary skill in the art from this disclosure, in one or more embodiments.

As used herein, the terms “comprises”, “comprising”, includes”, “including”, “has”, “having”, or any other variation thereof, are intended to cover a non-exclusive inclusion. For example, a process, method, article, or apparatus that comprises a list of elements is not necessarily limited to only those elements, but may include other elements not expressly listed or inherent to such process, method, article, or apparatus.

Similarly, it should be appreciated that in the description, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that any claim require more features than are expressly recited in that claim. Rather, inventive aspects lie in a combination of fewer than all features of any single foregoing disclosed embodiment.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B is true (or present).

As used in the specification, and in the appended claims, the singular forms “a”, “an”, “the”, include plural referents unless the context clearly dictates otherwise. This is done merely for convenience and to give a general sense of the inventive concept. This description should be read to include one or more and the singular also includes the plural unless it is obvious that it is meant otherwise. Thus, for example, reference to a “processor” is a reference to one or several processors and equivalents thereof known to those skilled in the art, and so forth.

As used herein, reference to “some embodiments”, “one embodiment”, “an embodiment”, “one example”, or “an example” means that a particular element, feature, structure, or characteristic described in connection with the embodiment may be included in at least one embodiment. The appearance of the phrase “in one embodiment” or “one example” in various places within the instant specification are not necessarily all referring to the same embodiment or example.

The following terms as used herein have the meanings indicated.

The term “module” refers to computer program code adapted to provide the functionality attributed to the module upon execution by a processor. In other embodiments, the “module” could be a special purpose circuitry (e.g. ASICs, PLDs, etc).

The term GPS refers to any navigational system involving satellites and computers for determining the latitude and longitude of a receiver on Earth by computing the time difference for signals from different satellites to reach the receiver (examples are GPS, GLONASS and Galileo).

The term “geographic information system (GIS)” refers to a computer system or a module designed to allow users and/or other computer systems and/or other modules to collect and/or manage and/or analyze spatially referenced information.

The terms “receive” or “receiving” means to gather, take, acquire, obtain, accept, get, and/or have bestowed upon.

The terms “acquire”, “acquiring” or “acquisition” should be broadly construed and may be in reference to determination, computation, reception, and/or other method of obtaining.

The terms “deliver” or “delivering” shall be understood to encompass both transmitting, downloading and uploading, or any combination thereof.

The term “rideshare trip” refers to a journey on a vehicle with occupancy of two or more persons.

The terms “participant”, “user”, “rideshare participant” or any lingual variations thereof are interchangeable and refer to a person or a group of persons using the methods of the present invention.

The term “passenger” refers to a participant that expressed his/her intention to go on a rideshare trip as a passenger of a vehicle.

The term “driver” refers to a participant that expressed his/her intention to go on a rideshare trip as a driver of a vehicle.

The term “rideshare agreement (RA)” refers to an arrangement between two or more rideshare participants. Such an arrangement comprises terms and conditions relating to various parameters of one or more rideshare trips.

The term “preliminary rideshare agreement” refers to a preliminary arrangement between two or more rideshare participants. Such an arrangement requires additional confirmation from at least one of the parties of the arrangement. A preliminary rideshare agreement may be set one-time or on a recurring basis such as, for example, every business day or every Monday.

The term “rideshare server” refers to a computing device, configured to provide rideshare participants various services related to rideshare trips, such as registration, authorization, matching, planning, scheduling, tracking, security, processing feedback and so forth.

The term “rideshare participant device” refers to a computing device, configured to provide its user with an interface to services provided by a rideshare server and/or other rideshare participant devices. In a peer-to-peer mode of operation, a rideshare participant device may additionally have some or all of the properties of a rideshare server.

The term “rideshare request” refers to a query to a rideshare server and/or to other rideshare participant devices corresponding to the user's intention to establish a rideshare agreement. A rideshare request may include various terms and conditions that the user deems necessary or desirable.

The term “match”, when used as a noun, refers to an affirmative comparison between rideshare requests of two or more rideshare participants.

The terms “ride-matching”, “matching” or “match”, when used as a verb, refer to a procedure of comparison between rideshare requests of two or more rideshare participants.

The term “time information” refers to any chronological information, such as time-of-day, or time interval between time-of-day and a predefined point in time.

The term “meeting location” refers to a geographic location or area where the rideshare trip is to be started from according to the rideshare agreement.

The term “meeting location information” refers to any data that is used to identify the meeting location.

The term “meeting time” refers to a time when the rideshare participants are to be at the meeting location according to the rideshare agreement.

The term “original vehicle location” refers to a geographic location of the vehicle at a particular time prior to the meeting time. In some embodiments, the particular time is the time of determining the scheduling information.

The term “original vehicle location information” refers to any data that is used to identify the original vehicle location.

The terms “current user location” or “current location”, unless stated otherwise, refer to a geographic location of the user at a particular time prior to the meeting time. In some embodiments, the particular time is the time of determining the scheduling information.

The terms “current user location information” or “current location information”, unless stated otherwise, refer to any data that is used to identify the current user location.

The term “pre-meeting driving time” refers to the estimated amount of time required for the driver to drive from the original vehicle location to the meeting location.

The term “readiness time interval of the passenger (passenger RTI)” refers to an amount of time since the scheduling information is determined required for the passenger for getting ready to meet the driver at the meeting location.

The term “readiness time interval of the driver (driver RTI)” refers to an amount of time since the scheduling information is determined required for the driver for getting ready to start driving from the original vehicle location.

The term “readiness time interval (RTI)” refers either to a passenger RTI or to a driver RTI.

The term “readiness information” refers to information and/or a signal allowing a rideshare server and/or a rideshare participant device to determine the corresponding RTI. Readiness information may comprise the RTI, a reference to a location in the device's memory where the RTI is stored, instructions and/or parameters' values to calculate the RTI, current user location information, current velocity of the user and so forth. In embodiments where the readiness information refers to a signal, the RTI may be determined using a predefined value.

The term “base time” refers to a time at which the scheduling information is determined.

The term “effective readiness time interval (ERTI)” refers to information corresponding to a time interval between the base time and the scheduled meeting time.

The term “scheduling information (SI)” refers to information allowing a rideshare participant device to provide its user with information allowing the user to find out when he/she is supposed to meet other participant(s) of trip provided that a rideshare agreement is established. For example, this information may comprise scheduled meeting time, amount of time left (time interval between current time and scheduled meeting time), ERTI and so forth.

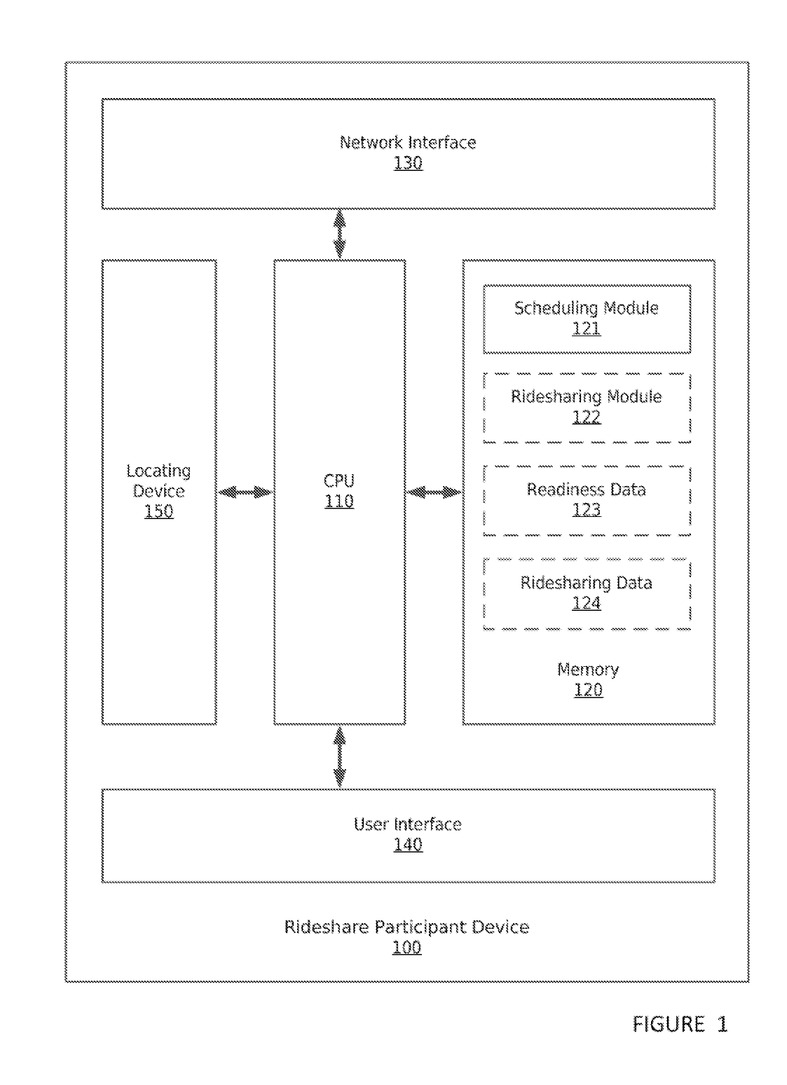

FIG. 1 illustrates an exemplary rideshare participant device 100 suitable for use in a client-server environment in accordance with some embodiments of the present invention. The rideshare participant device 100 typically comprises a processor 110, memory 120, network interface 130 and user interface 140. In some embodiments, the rideshare participant device 100 also comprises a locating device 150.

The processor 110 controls the overall operation of the rideshare participant device 100. The memory 120 comprises storage locations that are addressable by the processor 110 for storing program code and data structures used to perform the technique introduced herein. The processor 110, in turn, comprise processing elements and/or logic circuitry configured to execute the program code and manipulate various data structures. The code stored in the memory 120 comprises scheduling module 121 and, in some embodiments, ridesharing module 122. The data structures stored in the memory 120 may comprise readiness data 123 and/or ridesharing data 124.

The ridesharing module 122 may be configured to perform various operations that facilitate providing the user with the various services related to rideshare trips, such as registration, authorization, matching, planning, tracking, providing security, processing feedback and so forth. Those skilled in the art will recognize that the ridesharing module 122 may be substituted with a plurality of modules, each associated with at least one service, i.e. a ride-matching module, a feedback module and so forth.

The scheduling module 121 may operate in one of at least two modes of operation: a passenger mode of operation and a driver mode of operation. The scheduling module may be configured to receive user input via user interface 140, determine the readiness information corresponding to the user input and provide the rideshare server 200 with the readiness information. In the driver mode of operation, the scheduling module 121 may also determine the original vehicle location via the user interface 140 and/or via the locating device 150 and provide the rideshare server 200 with original vehicle location information. In some embodiments, the scheduling module 121 may be further configured to receive scheduling information from the rideshare server 200. In some embodiments, the scheduling module 121 may be even further configured to provide the user with the scheduling information.

Those skilled in the art will recognize that instead of configuring a single module to operate in the at least two modes of operation, the scheduling module 121 may be substituted with two or more modules, each operating in one of the at least two modes, i.e. a driver scheduling module, operating in the driver mode, and a passenger scheduling module, operating in the passenger mode. In some embodiments, the scheduling module 121 may be combined with the ridesharing module 122 or another module, related to rideshare trips, such as, for example, a ride-matching module, or not related to rideshare trips, such as, for example, a planning module.

The readiness data 123 may comprise readiness information. The readiness information may correspond to a rideshare trip or a plurality of rideshare trips.

The ridesharing data 124 may comprise various information related to the ridesharing module 122. For example, it may comprise user credentials for authorization (such as username and password), a set of rideshare requests (active, i.e. immediately available for ridematching, and/or inactive), a set of stored geographic locations (for creating and/or modifying of rideshare requests), matching information for selecting and/or approving a match, and so forth. Though not shown in the figures, the whole or some part of the ridesharing data 124 may be located outside the rideshare participant device 100 and, instead be accessible via the network interface 140.

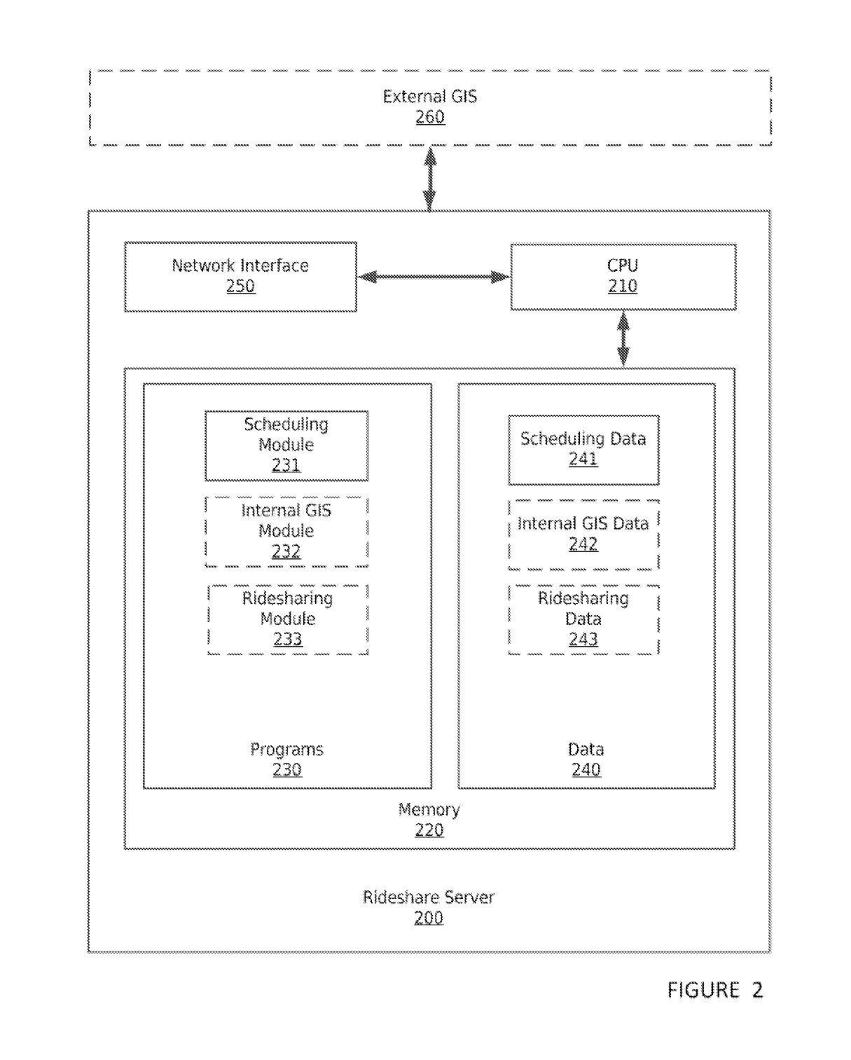

The network interface 130 comprises mechanical, electrical and signaling circuitry needed to connect the rideshare participant device 100 to a rideshare server 200 (shown in FIG. 2) and/or other devices external to the rideshare participant device 100.

The user interface 140 may provide multiple ways for the user to control or use the various functions provided. The user interface 140 may comprise user input devices, such as a keyboard, mouse, light pen, touch screen, as well as user output devices, such as such as a display, speaker or other audio device.

The locating device 150 may be any device providing geo-location information. In some embodiments, the locating device 150 comprises a GPS receiver.

It will be appreciated that rideshare participant device 100 may be any suitable computing device configured to execute the modules described herein. For example, the computing device may be a personal computer, laptop computer, computer-enabled wireless telephone, computing tablet, and so forth.

FIG. 2 illustrates an exemplary rideshare server 200 suitable for use in accordance with some embodiments of the present invention. The server 200 typically comprises a processor 210, memory 220 and server network interface 250. The processor 210 controls the overall operation of the server 200. The memory 220 comprises storage locations that are addressable by the processor 210 for storing program code 230 and data structures 240 used to perform the technique introduced herein. The processor 210, in turn, comprise processing elements and/or logic circuitry configured to execute the program code and manipulate various data structures.

The program code 230 comprises scheduling module 231. In some embodiments, the program code 230 may comprise internal GIS module 232 and/or ridesharing module 233. The data structures 230 comprises scheduling data 241. In some embodiments, the data structures 230 may also comprise internal GIS data 242 and/or ridesharing data 243.

The rideshare server 200 may be configured to communicate with rideshare participant devices (shown in FIG. 1) operating in client-server mode by means of the network interface 250.

The ridesharing module 231 may be configured to perform various operations that facilitate providing users of the rideshare participant devices with the various services related to rideshare trips, such as registration, authorization, matching, planning, tracking, providing security, processing feedback and so forth. Those skilled in the art will recognize that the ridesharing module 233 may be substituted with a plurality of modules, each associated with at least one service, i.e. a ride-matching module, a feedback module and so forth.

The scheduling module 231 may be configured to receive readiness information and/or original vehicle location from at least some of the rideshare participant devices, determine meeting location and pre-meeting driving time, and determine scheduling information corresponding. In some embodiments, the scheduling module 231 may be further configured to deliver the scheduling information to at least some of the rideshare participant devices.

The internal GIS module 232 is configured to plan a path from a first geographic location or area to a second geographic location or area and provide route information, such as a length of the planned path, lengths of segments of the planned path, estimated time, required to drive along the planned path, and so forth.

The scheduling data 241 may comprise various information related to the scheduling module 231. In some embodiments, the scheduling data 241 may comprise one or more records each corresponding to a rideshare trip. Each record may comprise readiness information, original vehicle information and meeting locations corresponding to at least some of the rideshare participant devices and pre-meeting driving times and scheduling information corresponding to at least some of the meeting locations. In other embodiments, the scheduling data 241 may be organized differently and may comprise different and/or additional data structures, such as one or more records each corresponding to at one of the users of the rideshare participant devices, one or more records each corresponding to a meeting location and so forth.

The internal GIS data 242 may comprise various information related to internal GIS module 362.

For example, the internal GIS data 242 may comprise spatially-referred information such as cartographic information, geolocation information, reverse geolocation information and so forth.

The ridesharing data 243 may comprise various information related to the ridesharing module 231. For example, the ridesharing data 243 may comprise user accounts information, rideshare requests (active, i.e. immediately available for ridematching, and/or inactive), matching information, and so forth. Though not shown in the figures, the whole or some part of the ridesharing data 243 may be located outside the rideshare server 200 and, instead be accessible via the network interface 250.

The network interface 250 comprises mechanical, electrical and signaling circuitry needed to connect the rideshare server 200 to the rideshare participant devices and, in some embodiments, to external GIS 260 and/or other devices external to the rideshare server 200.

The external GIS 260 is configured to plan a path from a first geographic location or area to a second geographic location or area and provide route information, such length of the planned path, lengths of segments of the planned path, estimated time required to drive along the planned path, and so forth.

It will be appreciated that the rideshare server 200 may be any suitable computing device configured to execute the modules described herein. For example, the computing device may be a special-purpose computer, a personal computer, and so forth.

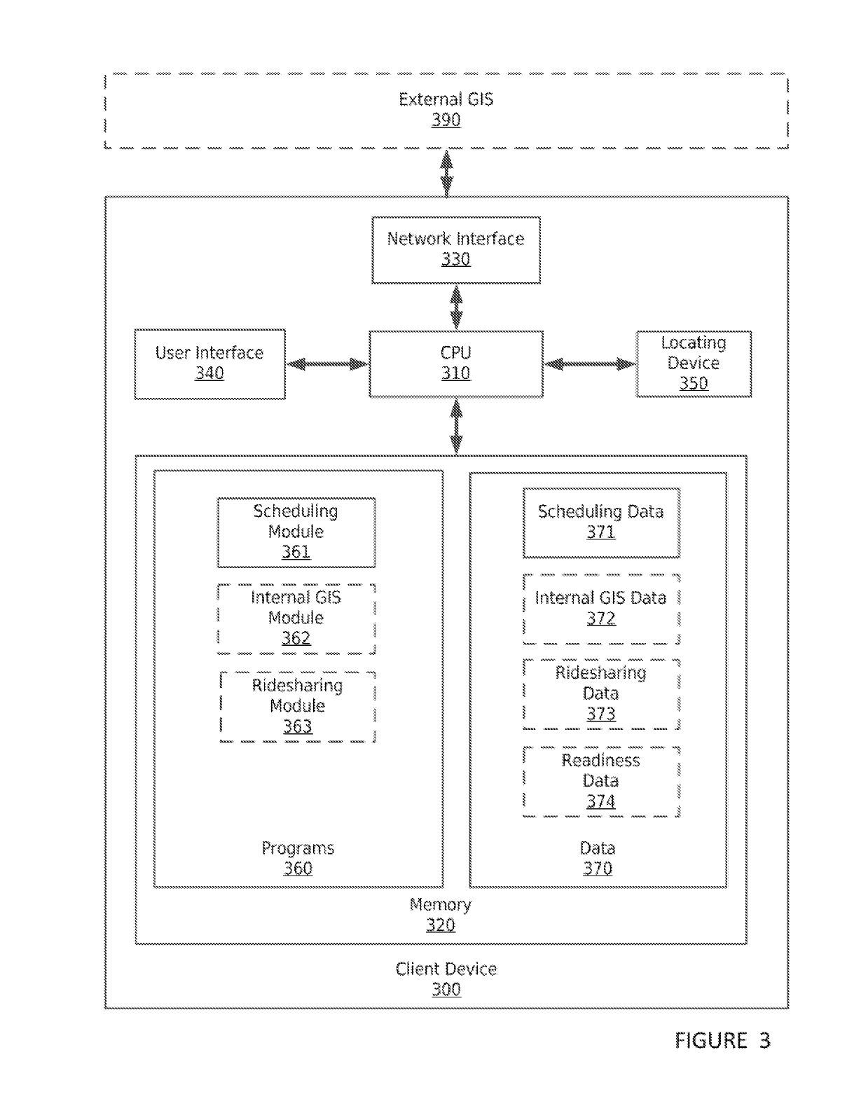

FIG. 3 illustrates an exemplary rideshare participant device 300 suitable for use in a peer-to-peer environment in accordance with some embodiments of the present invention. The rideshare participant device 300 typically comprises a processor 310, memory 320, network interface 330 and user interface 340. In some embodiments, the rideshare participant device 100 also comprises a locating device 350.

The processor 310 controls the overall operation of the rideshare participant device 300. The memory 320 comprises storage locations that are addressable by the processor 310 for storing program code 360 and data structures 370 used to perform the technique introduced herein. The processor 310, in turn, comprise processing elements and/or logic circuitry configured to execute the program code 360 and manipulate various data structures.

The program code 360 comprises scheduling module 361. In some embodiments, the program code 360 may comprise internal GIS module 362 and/or ridesharing module 363. The data structures 370 comprises scheduling data 371. In some embodiments, the data structures 370 may also comprise internal GIS data 372 and/or ridesharing data 373 and/or readiness data 374.

The rideshare participant device 300 may be configured to communicate with other rideshare participant devices operating in peer-to-peer mode (the peer devices) by means of the network interface 330.

The ridesharing module 363 may be configured to perform various operations that facilitate providing the user and/or users of the peer devices with the various services related to rideshare trips, such as registration, authorization, matching, planning, tracking, providing security, processing feedback and so forth. Those skilled in the art will recognize that the ridesharing module 363 may be substituted with a plurality of modules, each associated with at least one service, i.e. a ride-matching module, a feedback module and so forth.

The scheduling module 361 may operate in one of at least two modes of operation: a passenger mode of operation and a driver mode of operation. In the passenger mode of operation, the scheduling module may be configured to receive user input via user interface 340, determine readiness information corresponding to the user input and provide at least some of the peer devices with the readiness information. In the driver mode of operation, the scheduling module 121 may be configured to receive user input via user interface 330, determine readiness information corresponding to the user input, determine the original vehicle location via the user interface 340 and/or via the locating device 350, determine meeting location, determine pre-meeting driving time by means of internal GIS module 362 and/or external GIS module 390, and determine scheduling information. In some embodiments, the scheduling module 361 may be further configured to deliver the scheduling information to at least some of the peer devices in the driver mode of operation, and to receive the scheduling information from at least some of the peer devices in the passenger mode of operation. In some embodiments, the scheduling module 361 may be further configured to provide the user with the scheduling information.

Those skilled in the art will recognize that instead of configuring a single module to operate in the at least two modes of operation, the scheduling module 361 may be substituted with two or more modules, each operating in one of the at least two modes, i.e. a driver scheduling module, operating in the driver mode, and a passenger scheduling module, operating in the passenger mode. In some embodiments, the scheduling module 361 may be combined with the ridesharing module 363 or another module, related to rideshare trips, such as, for example, a ride-matching module, or not related to rideshare trips, such as, for example, a planning module.

The internal GIS module 362 is configured to plan a path from a first geographic location or area to a second geographic location or area and provide route information, such as a length of the planned path, lengths of segments of the planned path, estimated time, required to drive along the planned path, and so forth.

The scheduling data 371 may comprise various information related to the scheduling module 361. In some embodiments, it may comprise readiness information and meeting locations corresponding to at least some of the peer devices and pre-meeting driving times and scheduling information corresponding to at least some of the meeting locations.

The internal GIS data 372 may comprise various information related to internal GIS module 362. For example, the internal GIS data 372 may comprise spatially-referred information such as cartographic information, geolocation information, reverse geolocation information and so forth.

The ridesharing data 373 may comprise various information related to the ridesharing module 122. For example, the ridesharing data 373 may comprise user credentials for authorization (such as username and password), a set of rideshare requests (active, i.e. immediately available for ridematching, and/or inactive) corresponding to the account of the user, a set of rideshare requests received from at least some of the peer devices, a set of stored geographic locations (for creating and/or modifying of rideshare requests), matching information for selecting and/or approving a match, and so forth. Though not shown in the figures, the whole or some part of the ridesharing data 373 may be located outside the rideshare participant device 300 and, instead be accessible via the network interface 330.

The readiness data 374 may comprise readiness information corresponding to the user. The readiness information may correspond to a rideshare trip or a plurality of rideshare trips.

The user interface 340 may provide multiple ways for the user to control or use the various functions provided. The user interface 340 may comprise user input devices, such as a keyboard, mouse, light pen, touch screen, as well as user output devices, such as such as a display, speaker or other audio device.

The locating device 350 may be any device providing geo-location information. In some embodiments, the locating device 350 comprises a GPS receiver.

The network interface 330 comprises mechanical, electrical and signaling circuitry needed to connect the rideshare participant device 300 to other peer rideshare participant devices and, in some embodiments, to external GIS 390 and/or other devices external to the rideshare participant device 300.

The external GIS 390 is configured to plan a path from a first geographic location or area to a second geographic location or area and provide route information, such as a length of the planned path, lengths of segments of the planned path, estimated time, required to drive along the planned path, and so forth.

It will be appreciated that rideshare participant device 300 may be any suitable computing device configured to execute the modules described herein. For example, the computing device may be a personal computer, laptop computer, computer-enabled wireless telephone, computing tablet, and so forth.

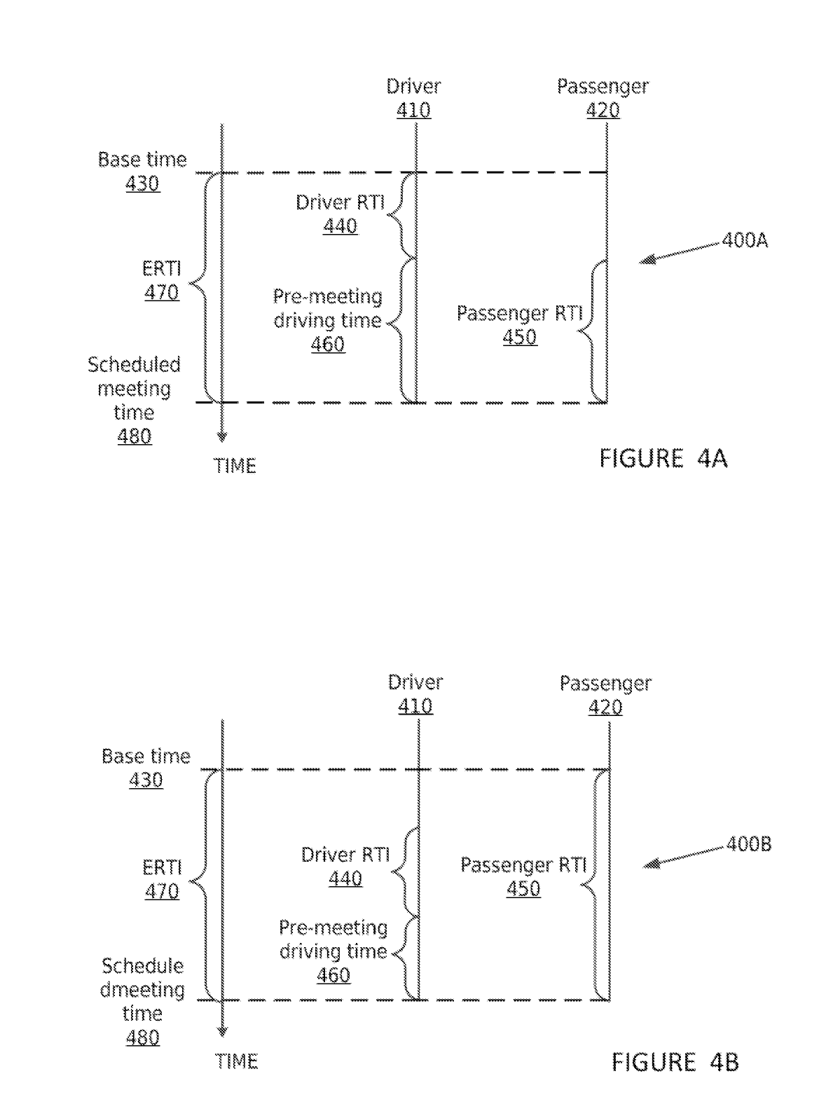

FIGS. 4A and 4B are timeline diagrams illustrating scheduling for a rideshare trip in accordance with some embodiments of the present invention.

In some embodiments, the base time 430 corresponds to the time at which the rideshare agreement is established. In further embodiments, the scheduling information may be determined in response to establishing the rideshare agreement.

In other embodiments, the scheduling information may be determined during ride-matching. In these embodiments, the base time 430 corresponds to the time of ride-matching. Matching procedure may benefit from using limits to the ERTI 470 corresponding to the scheduling information, so that it must be below a predefined threshold value or within a predefined range of values, in order to produce a match. For example, the passenger 420 may use a “60 minute maximum waiting time” limit in his/her rideshare request. Accordingly, if the ERTI is determined to be above 60 minutes, the rideshare request of the passenger 420 won't be matched with the rideshare request of the driver 410.

In yet other embodiments, the base time 430 may correspond to the current time. In particular, the scheduling information may be determined to provide the user with results of “what-if” analysis before establishing the rideshare agreement, allowing the user to find out what the meeting time would be if the rideshare agreement is established at the current time. After that the user may evaluate the scheduling information and take actions for establishing the rideshare agreement, if the user decides to do so, After that, if the rideshare agreement is established, the scheduling information may be re-determined with the base time 430 set to the time of establishing the rideshare agreement.

The ERTI 470 corresponds to a time interval between the base time 430 and the scheduled meeting time 480. In some embodiments, the ERTI 470 is determined as the estimated amount of time that it takes for both the driver 410 and the passenger 420 to get to the meeting location. In further embodiments, the ERTI is determined as the maximum of the amount of time, required by the driver 410 to get to the meeting place, calculated as the sum of the driver RTI 440 and the pre-meeting driving time 460, and the amount of time, required by the passenger 420 to get to the meeting place, calculated as the passenger RTI 450.

A participant's RTI may comprise an amount of time, corresponding to a walk from the participant's current location to the meeting location or the original vehicle location (for the passenger 420 and the driver 410, respectively) and/or an amount of time related to other activities of the participant. These activities may be, or may not be, related to the rideshare trip. If the RTI comprise the amount of time, corresponding to the walk, these activities can be carried out before the walk, after the walk or concurrently. Examples of such activities are “finishing current task at work”, “buying a cup of coffee at a vending machine near the meeting place”, “dressing up”, “waiting for the vehicle's engine to get warm” and so forth. Typically, the participant estimates and sets the RTI himself/herself, however, in some embodiments, the RTI may be based, at least in part, on estimations carried out by a rideshare server and/or by a rideshare participant device.

It will be appreciated that the timelines 400A and 400B provide only simplified illustrations of scheduling. In practice, additional delays and scheduling adjustments may be included, some of which are discussed in further detail below.

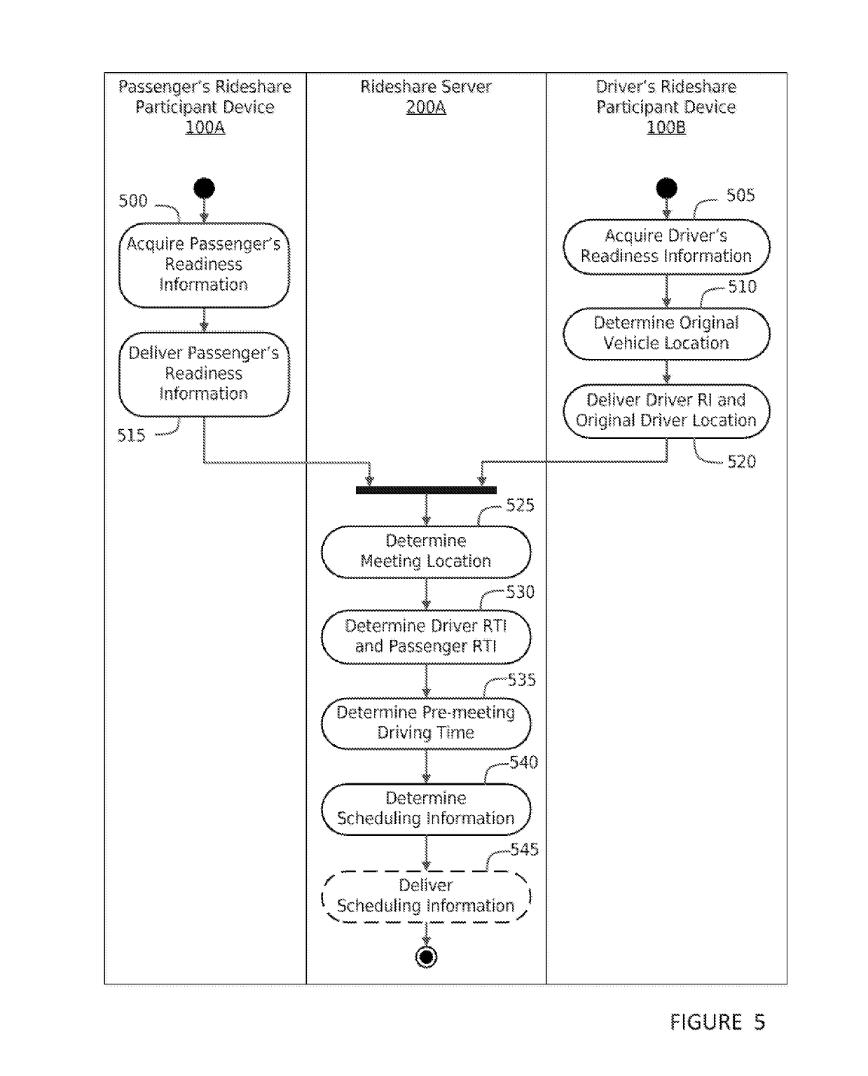

FIG. 5 illustrates steps performed by rideshare server 200A, rideshare participant device 100A and rideshare participant device 1008 in accordance with some embodiments of the present invention.

In step 500, the rideshare participant device 100A acquires readiness information of the passenger 420. In step 505, rideshare participant device 100B acquires readiness information of the driver 410. In most embodiments, the acquisition of a participant's readiness information comprises receiving a signal or a request from the participant by means of the user interface 140. In some embodiments, a participant's readiness information comprises the participant's RTI. In these embodiments, determination of an RTI may be accomplished, for example, by receiving user input that define the value of the RTI by means of the user interface 140. In various embodiments, the readiness information may comprise information about current location of the participant, its velocity and so forth. Such information may be determined by means of the locating device 150. In some embodiments, the readiness information may comprise time of the user input.

In step 510 the rideshare participant device 100B determines original vehicle location. In some embodiments or modes of operation, this may be accomplished by receiving user input by means of the user interface 140. The user may be provided with several options to define the original vehicle location. The list of options may comprise the user's current location, the user's previous locations, location of the user's car, locations predefined by the user, points of interest (POIs), landmarks, public transport stations and so forth. In other embodiments or modes of operation, a map may be displayed on a display of the rideshare participant device 100B to allow the user to select the original vehicle location on the map. In still other embodiments or modes of operation, the original vehicle location may be determined automatically based upon the current location of the rideshare participant device 100B. The current location may be determined by the locating device 150.

In step 515 the rideshare participant device 100A delivers the readiness information of the passenger 420 to the rideshare server 200A. In step 520 the rideshare participant device 100B delivers the readiness information of the driver 410 and the original vehicle location to the rideshare server 200A. It will be appreciated that the rideshare server 200A may, in some embodiments, determine times of the delivery operations. (Durations of the delivery operations are neglected.)

The steps 500 and 515, executed on the rideshare participant device 100A may be executed before, after or simultaneously with the steps 505, 510 and 520, executed on the rideshare participant device 100B. The step 625 is executed after both the steps 515 and 520 are executed.

In step 525 rideshare server 200A determines the meeting location. In some embodiments, the meeting location information may be obtained directly from the rideshare agreement and/or the preliminary rideshare agreement without additional processing being performed. In other embodiments, the meeting location may be derived from information contained in the rideshare agreement and/or the preliminary rideshare agreement and/or the readiness information of the passenger 420 and/or the readiness information of the driver 410 and/or the original vehicle location. For example, the preliminary rideshare agreement may comprise meeting location information that can be modified depending on the original vehicle location information so that the pre-meeting driving time is minimized.

In step 530 the passenger RTI 450 and the driver RTI 440 are determined by the rideshare server 200A. In some embodiments, at least one of the RTIs may be obtained directly from the corresponding readiness information without additional processing being performed. In other embodiments, at least one of the RTIs may be set to a value unrelated to the corresponding readiness information, such as, for example, a predefined value or a value based on some estimation.

In still other embodiments, at least one of the RTIs may be derived from the value of the corresponding readiness information and/or time of the corresponding delivery operation. In embodiments or modes of operation, where the corresponding readiness information comprises current location of the user, a walking distance may be determined, if the user is a passenger, as the distance between current location of the user and the meeting location or, if the user is a driver, as the distance between current location of the user and the original vehicle location. Consequently, an estimated amount of time required for walking the walking distance (the walking time) may be derived based, at least in part, on the walking distance and, optionally, the user's velocity and/or the user's current speed and/or the user's historic average speed. In further embodiments, the passenger RTI may be set to a value significantly larger than the walking time, if the user's current location is within a building, e.g. at home or in an office, and/or if his/her current speed is lower than a predefined threshold value (e.g. 1 km/h). For example, if the user is sitting at home and the walking time is 5 minutes, the RTI may be set to 30 minutes. Conversely, the user's RTI may be set to the walking time or a value significantly close to the walking time, if the user's current location is outside a building, and/or his/her current speed is a within a predefined range (e.g. 2-10 km/h). For example, if the passenger is on his/her way to a public transport station and the walking time is 1 minute, the RTI may be set to 1 minute. The value of the RTI may be selected from a set of predefined values or calculated operatively.

In step 535 the rideshare server 200A determines the pre-meeting driving time 460. This estimation is based at least in part on route information provided by a GIS. In some embodiments, the GIS is the external GIS 260 and, in other embodiments, the GIS is the internal GIS module 232. The GIS is provided with the original vehicle location information and the meeting location information. In some embodiments, in order for the GIS to take traffic information into consideration, the GIS may estimate time or time interval of the rideshare trip. In order for the GIS to do so, it may be provided with various time information associated to the planned ride, such as times of the users providing input in the steps 500 and 505, times of starting and/or finishing of the delivery operations in the steps 515 and 520 and so forth. In some embodiments, the GIS may be provided with driver speed information. In various embodiments the driver speed information may be constant, predefined by the driver, determined based upon previous driver rides within the system, and so forth.

After the GIS is provided with said information, the GIS plans a path for a vehicle from the original vehicle location to the meeting location and determines route information. In various embodiments, the route information may comprise a length of the planned path, lengths of segments of the planned path, estimated time required to drive along the planned path, and so forth. In embodiments, where the GIS does not provide the estimated time required to drive along the planned path, this value may be calculated based on the route information and the driver speed information.

In step 540 the rideshare server 200A determines scheduling information. The determination of the scheduling information is based, at least in part, on the ERTI 470 which in turn is calculated as a function of the passenger RTI 450, the driver RTI 440 and the pre-meeting driving time 460. In further embodiments, the ERTI 470 is calculated as the maximum of the passenger 450 RTI and the sum of the driver RTI 440 and the pre-meeting driving time 460. In embodiments where the scheduling information comprises the scheduled meeting time 480, the later is calculated as a function of the ERTI 470 and the base time 430. The amounts of time required for delivering the readiness information, the amounts of time required for determination of the scheduling information and the amounts of time required for delivering the scheduling information are neglected because these amounts are much smaller than RTIs. In further embodiments, the scheduled meeting time is calculated as the sum of the ERTI 470 and the time value corresponding to the base time information.

In optional step 545 the rideshare server 200A delivers the scheduling information to the rideshare participant device 100A and/or the rideshare participant devices 1008. It will be appreciated that at least one of the rideshare participant devices may, in some embodiments, determine times of start and/or finish of the corresponding delivery operations.

Though not shown in the figures, in some embodiments, the determination of the scheduling information may be performed on the rideshare participant device 100A and/or on the rideshare participant device 100B. In these embodiments, the rideshare server 200A instead of the steps 540-545 may deliver intermediate information, sufficient for automatic determination of the scheduling information to the rideshare participant device 100A and/or the rideshare participant device 100B. In the case where the rideshare participant device 100A is to determine the scheduling information, the intermediate information comprises at least the driver RTI 440 and the pre-meeting driving time 460. The passenger RTI 450 may be either determined by the rideshare participant device 100A or be comprised in the intermediate information. In the case where the rideshare participant device 100B is to determine the scheduling information, the intermediate information comprises at least the passenger RTI 450 and the pre-meeting driving time 460. The driver RTI 440 may be either determined by the rideshare participant device 100B or be comprised in the intermediate information. In such embodiments, the determination of the scheduling information is performed the same way as in the step 540. In further embodiments, the intermediate information may also comprise the base time information. In other further embodiments the base time information may be determined based on the times of start and/or finish of the delivery of the intermediate information. In yet other embodiments, the base time information may be based on the current time.

The rideshare participant device that determines the scheduling information may deliver the scheduling information to the other rideshare participant device.

After the scheduling information becomes available to a rideshare participant device, the rideshare participant device may provide its user with the scheduling information by means of the user interface 140.

Those skilled in the art will recognize that in other embodiments the sequence of the steps may differ from the one illustrated in FIG. 5. For example, the step 525 may be executed after step the 530.

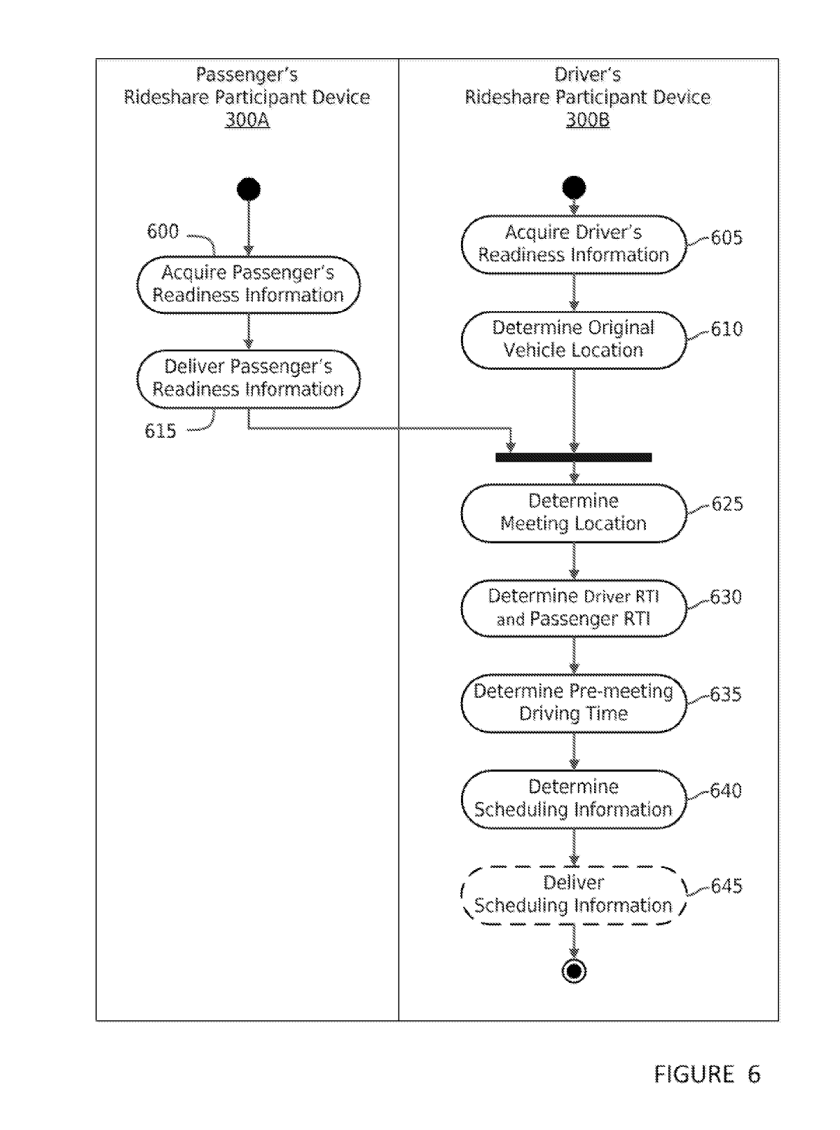

FIG. 6 illustrates steps performed by the rideshare participant device 300A and the rideshare participant device 300B in accordance with some embodiments of the present invention.

In step 600, the rideshare participant device 300A acquires readiness information of the passenger 420. In step 605, rideshare participant device 300B acquires readiness information of the driver 410. In most embodiments, the acquisition of a participant's readiness information comprises receiving a signal or a request from the participant by means of the user interface 340. In some embodiments, the participant's readiness information comprises the participant's RTI. In these embodiments, determination of an RTI may be accomplished, for example, by receiving user input that define the value of the RTI by means of the user interface 340. In various embodiments, the readiness information may comprise information about current location of the participant, its velocity and so forth. Such information may be determined by means of the locating device 350. In some embodiments, the readiness information may comprise time of the user input.

In step 610 the rideshare participant device 300B determines original vehicle location. In some embodiments or modes of operation, this may be accomplished by receiving user input. User may be provided with several options to define original vehicle location. The list of options may comprise user's current location, user's previous locations, location of user's car, locations predefined by user, points of interest (POIs), landmarks, public transport stations and so forth. In other embodiments or modes of operation, a map may be displayed on a display of rideshare participant device 300B to allow user to select original vehicle location on the map. In still other embodiments or modes of operation, original vehicle location may be determined automatically based upon the current location of the rideshare participant device 300B. The current location may be determined by the locating device 350.

In step 615 the rideshare participant device 300A delivers the readiness information of the passenger 420 to the rideshare participant device 300B. It will be appreciated that the rideshare participant device 300B may, in some embodiments, determine time of the delivery operation. (Duration of the operation is neglected.)

The steps 600 and 615, executed on the rideshare participant device 100A may be executed before, after or simultaneously with the steps 605 and 610, executed on the rideshare participant device 300B. Step 625 is executed after both step 615 and step 610 are executed.

In step 625 rideshare participant device 300B determines meeting location. The determination is performed in the same way as in the step 525 in FIG. 5.

In step 630 the passenger RTI 450 and the driver RTI 440 are determined by the rideshare participant device 300B. The determination is performed in the same way as in the step 530 in FIG. 5.

In step 635 the rideshare participant device 300B determines the pre-meeting driving time 460. This estimation is based at least in part on route information provided by a GIS. In some embodiments, the GIS is the external GIS 390 and, in other embodiments, the GIS is the internal GIS module 362. The determination of the route information is performed in the same way as in the step 535 in FIG. 5.

In step 640 the rideshare participant device 300B determines scheduling information. The determination is performed in the same way as in the step 540 in FIG. 5.

In optional steps 645 the rideshare participant device 300B delivers the scheduling information to the rideshare participant device 300A.

After the scheduling information becomes available to the respective rideshare participant device, the rideshare participant device may provide its user with the scheduling information by means of the user interface 340.

Those skilled in the art will recognize that in other embodiments the sequence of steps may differ from the one illustrated in FIG. 6. For example, the step 610 may be executed after the step 625.

What is claimed is:

1. A method for facilitating automatic scheduling of a meeting between a driver and a passenger for a rideshare trip, comprising the steps of:
(a) acquiring readiness information of the passenger;
(b) acquiring readiness information of the driver;
(c) acquiring an original vehicle location;
(d) determining a meeting location corresponding to the meeting for the rideshare trip;
(e) determining, using a GIS, a pre-meeting driving time corresponding to the original vehicle location and the meeting location;
(f) determining a readiness time interval of the passenger corresponding to the readiness information of the passenger and a readiness time interval of the driver corresponding to the readiness information of the driver;
(g) determining scheduling information corresponding to the rideshare trip
wherein the step of determining scheduling information corresponding to the rideshare trip is based at least in part on a function of at least
the readiness time interval of the passenger,
the readiness time interval of the driver, and
the pre-meeting driving time;
wherein the method is performed on one or more computing devices.

2. A method as claimed in claim 1, wherein the original vehicle location is a
a geographic location of a vehicle of the driver determined by means of a locating device, such as a GPS receiver.

3. A method as claimed in claim 1, wherein the original vehicle location is
a geographic location specified by the driver by means of a user interface.

4. A method as claimed in claim 2 or 3, wherein the step of determining scheduling information corresponding to the rideshare trip is based at least in part on a function of at least
a maximum value of the readiness time interval of the passenger and the sum of the readiness time interval of the driver and the pre-meeting driving time.

5. A method as claimed in claim 4, wherein the step of acquiring readiness information of the passenger comprises
receiving the readiness information of the passenger, the readiness information of the passenger being originated from a rideshare participant device of the passenger.

6. A method as claimed in claim 4, wherein the step of acquiring readiness information of the driver comprises
receiving the readiness information of the driver, the readiness information of the driver being originated from a rideshare participant device of the driver.

7. A method as claimed in claim 6, wherein the step of acquiring original vehicle location comprises
receiving original vehicle location information, the original vehicle location information being originated from the rideshare participant device of the driver;

8. A method as claimed in claim 4, further comprising the step of
delivering the scheduling information to the rideshare participant device of the passenger and the rideshare participant device of the driver;
wherein the method is performed on a rideshare server.

9. A method as claimed in claim 5, further comprising the step of
delivering the scheduling information to the rideshare participant device of the passenger;
wherein the method is performed on the rideshare participant device of the driver, the device operating in a peer-to-peer environment.

10. A method as claimed in claim 5, further comprising the steps of:
(h) delivering the readiness time interval of the passenger and the pre-meeting driving time to the rideshare participant device of the driver;
(i) delivering the readiness time interval of the driver and the pre-meeting driving time to the rideshare participant device of the passenger;
wherein the steps (a) to (f) and (h) to (i) are performed on a rideshare server and the step (g) is performed on at least one of the rideshare participant device of the passenger and the rideshare participant device of the driver;
